(19) United States
(12) Patent Application Publication
(10) Pub. No.: US 2009/0052847 A1
(43) Pub. Date: Feb. 26, 2009

(54) OPTICAL FIBER RIBBON

(75) Inventors: Yoshihiro ARASHITANI, Tokyo (JP); Toshiaki Ozawa, Tokyo (JP); Kunihiko Yujoubou, Tokyo (JP); Zoltan Varallyay, Budapest (HU)

Correspondence Address: OBLON, SPIVAK, MCCLELLAND MAIER & NEUSTADT, P.C., 1940 DUKE STREET, ALEXANDRIA, VA, 22314, US

(73) Assignee: FURUKAWA ELECTRIC CO., LTD., Tokyo (JP)

(21) Appl. No.: 12/024,606

(22) Filed: Feb. 1, 2008

Related U.S. Application Data
(63) Continuation of application No. PCT/JP07/66266, filed on Aug. 22, 2007.

(51) Int. Cl. G02B 6/44

(52) U.S. Cl. 385/114

(57) ABSTRACT

An optical fiber ribbon and an optical fiber cable capable of suppressing deterioration of polarization mode dispersion and effective in improving the communication capacity in wavelength multiplex communication. In an optical fiber ribbon having a plurality of optical fibers 12 in a bundled form, and a ribbon coating layer 13 formed around the plurality of optical fibers so as to integrally combining the plurality of optical fibers, the glass transition temperature of the ribbon coating is within the range from 80 to 130° C.; the Young's modulus of the ribbon coating is within the range from 800 to 2100 MPa; the thickness a of the ribbon coating layer applied on the upper and lower sides of the plurality of optical fibers and the thickness b of the ribbon coating layer applied outside the optical fibers in the outermost positions in the optical fiber ribbon always satisfy 1<b/a≦2; the ribbon coating layer thickness a is 10 μm or less; and the ribbon coating layer thickness b is smaller than 20 μm.

### TECHNICAL FIELD

The present invention relates to an optical fiber ribbon.

### BACKGROUND ART

With the increase in capacity of wavelength multiplex communication and so on in the optical communication technology in recent years, a need has arisen to strictly control dispersion characteristics. In the present circumstances, therefore, it is necessary to control polarization dispersion characteristics or the like in optical fiber cables.

It is ideal that an optical fiber is truly circular in cross section. In reality, various asymmetries exist in a cross section of an optical fiber, including a deviation of a circular section from a true circle and an eccentricity. Such non-circularities in an optical fiber are attributed to manufacturing equipments and manufacturing conditions and therefore tend to be continuous in the longitudinal direction of the optical fiber instead of being localized in one cross section. When light propagates through an optical fiber having such non-circularities, a difference occurs between the propagation speeds in the X-polarization and Y-polarization modes to cause dispersion. This is polarization mode dispersion (PMD).

There have been proposed an optical fiber in which non-circularity existing in an optical fiber cross section is made non-continuous in the longitudinal direction by guiding the optical fiber with a guide roller periodically swung so that the optical fiber is given a predetermined twist when the optical fiber is drawn from an optical fiber preform, whereby the propagation speeds in the X-polarization and Y-polarization modes are made substantially equal to each other and polarization mode dispersion is reduced, and a method of manufacturing the optical fiber (see patent documents 1, 2, and 3).

A typical optical fiber ribbon is formed of a plurality of optical fibers placed side by side and a ribbon matrix with which the optical fibers are covered. Each optical fiber has a glass fiber made of quartz glass, a primary coating layer and a secondary coating layer. The optical fiber ribbon has a structure in which the plurality of optical fibers are placed side by side in a band form and integrated with each other; each adjacent pair of optical fibers are placed side by side in contact or not in contact with each other; and the optical fibers are collectively covered with a ribbon coating layer.

In an optical fiber ribbon constructed in this way, a structural characteristic is formed such that stresses respectively undergone by the individual optical fibers vary depending on the placed positions of the optical fibers due to asymmetries of the optical fiber ribbon cross section in the thickness and width directions. That is, in an optical fiber ribbon obtained by placing a plurality of optical fibers in a band form and combining the optical fibers integrally with each other by a ribbon coating surrounding the optical fibers, the individual optical fibers undergo stresses from the ribbon coating formed in the manufacturing process at their respective placed positions and, therefore, the stresses undergone by the optical fiber at an inner position in the ribbon and the optical fiber at an end differ in magnitude and direction from each other.

These asymmetries in the optical fiber ribbon cross section exist continuously in the longitudinal direction, and the individual optical fibers undergo different stresses. Therefore the difference between the polarization mode dispersions due to these stresses are increased between the individual optical fibers, and the polarization mode dispersion tends to worsen in the optical fiber ribbon and in an optical fiber cable having the optical fiber ribbons combined.

With respect to the above-described mechanism, a trial has been made to estimate stress applied to each glass fiber from the ribbon matrix around the optical fiber ribbon and the primary classing layer and the secondary coating layer provided on the periphery of the glass fiber and to predict birefringence in each optical fiber on the basis of the predicted value of the stress estimated (see non-patent document 1 and non-patent document 2).

From these studies, it has been reported that birefringence predicted on the basis of the estimated stress value well coincides with the tendency of polarization mode dispersion exhibited in each optical fiber in the optical fiber ribbon having the plurality of optical fibers combined. It can be understood that stresses residing in the optical fiber coating layer and the optical fiber ribbon coating closely relate to polarization mode dispersion.

Patent document 1: Japanese Patent Application Laid-Open No. H06-171970

Patent document 2: Japanese Patent Application Laid-Open No. H08-295528

Patent document 3: U.S. Pat. No. 5,822,487

Non-patent document 1: “Stress Distribution in Optical-Fiber Ribbons” A. Galtarossa et al., IEEE Photonics Technology Letters, Vol. 9, No. 3 March 1997

Non-patent document 2: “Effect of Fiber Displacements on Stress Distribution in 8-Fiber Ribbons” A. Galtarossa et al., ECOC 97, 22-25 Conference Publication No. 448

There is an objective to provide an optical fiber ribbon and an optical fiber cable capable of suppressing deterioration of polarization mode dispersion and effective in improving the communication capacity in wavelength multiplex communication.

### SUMMARY OF THE INVENTION

According to one aspect of the present invention, there is provided an optical fiber ribbon including a plurality of optical fibers having glass optical fibers and coating layers provided on clad peripheral surfaces of the glass optical fibers, the optical fibers being in a bundled form, and a ribbon coating formed around the plurality of optical fibers so as to integrally combining the plurality of optical fibers, wherein the glass transition temperature of the ribbon coating is within the range from 80 to 130° C.; the Young's modulus of the ribbon coating is within the range from 800 to 2100 MPa; the thickness a of the ribbon coating layer applied on the upper and lower sides of the plurality of optical fibers and the thickness b of the ribbon coating layer applied outside the optical fibers in the outermost positions in the optical fiber ribbon always satisfy 1<b/a≦2; the ribbon coating layer thickness a is 10 μm or less; and the ribbon coating layer thickness b is smaller than 20 μm.

According to the present invention, polarization mode dispersion can be suppressed to a low degree while provided sufficient toughness and maintaining separation ability into individual fibers and coating strip ability.

### BRIEF DESCRIPTION OF THE DRAWING

FIG. 1 is a sectional view of an embodiment of an optical fiber ribbon according to an embodiment of the present invention; and

FIG. 2 is a diagram for explaining thickness a of a ribbon coating layer applied on the upper and lower sides of optical fibers and thickness b of the ribbon coating layer applied outside the optical fibers in the outermost positions in the optical fiber ribbon.

### THE DESCRIPTION OF EMBODIMENTS

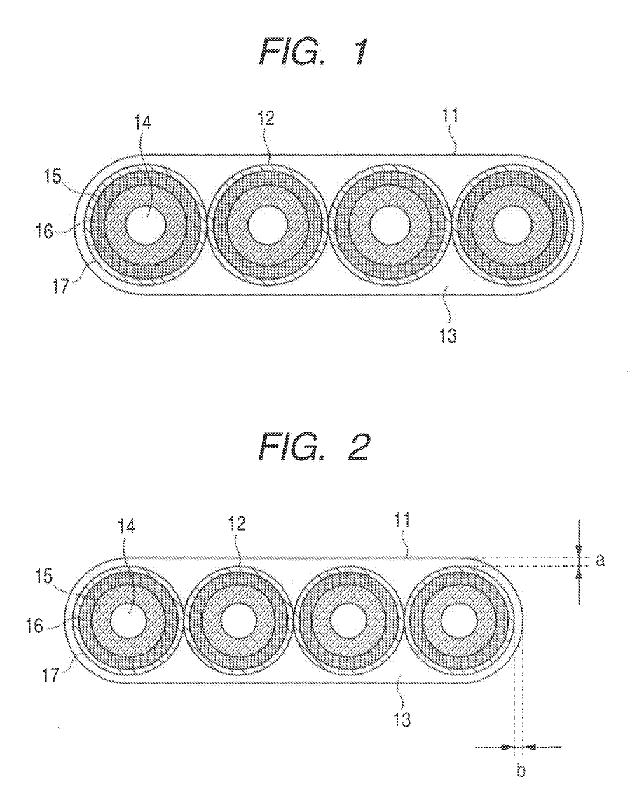

An embodiment of the present invention will be described with reference to the drawings. An embodiment of an optical fiber ribbon of the present invention has a sectional structure shown in FIG. 1. As shown in FIG. 1, an optical fiber ribbon 11 is constituted by an optical fiber 12 and a ribbon matrix 13. The optical fiber has a glass fiber 14 made of quartz glass, a primary coating layer 15 and a secondary coating layer 16. The optical fiber ribbon 11 has a structure in which a plurality of optical fibers 12 are placed side by side in a band form and made integral with each other; each adjacent pair of optical fibers 12 are placed side by side in contact or not in contact with each other; and the optical fibers 12 are collectively covered with a ribbon coating layer 13. FIG. 1 shows an optical fiber ribbon in which optical fibers are in contact with each other, and which is a 4-core optical fiber ribbon having four optical fibers 12.

In this optical fiber ribbon 11, an ultraviolet curing resin is used as a ribbon coating 13 on the peripheries of the four optical fibers 12 placed side by side in a band form. A thermoplastic resin, a thermosetting resin or the like may be used in place of the ultraviolet curing resin as the ribbon matrix 13.

In a case where an ultraviolet curing resin is used as the ribbon matrix 13 for integrally combining the optical fibers 12 placed side by side in a band form by ribbon coating the peripheral surfaces of the optical fibers 12, the ribbon matrix 13 is in liquid form at an initial stage of the manufacturing process. The ribbon matrix in liquid form is applied to the optical fibers placed side by side, passed through a die of a predetermined size and set with an ultraviolet lamp, thereby obtaining an optical fiber ribbon 11 of a desired shape and size.

In the step of curing the ribbon matrix 13 with an ultraviolet lamp, the resin is set while increasing its temperature by heat of exthalmalreaction in itself and expanding in volume. After the completion of setting, the ribbon matrix 13 gradually reaches equilibrium with room temperature. In the course of reaching equilibrium, the volume of the ribbon matrix 13 shrinks to apply compressive stress to the optical fibers 12. This stress is constant in each cross section of the optical fiber ribbon 11 and is fixed in the longitudinal direction. Therefore the difference between the propagation speeds in the X-polarization and Y-polarization modes produced in each cross section is accumulated without being randomized in the longitudinal direction, thereby increasing polarization mode dispersion in the optical fiber ribbon 11.

The inventors of the present invention have earnestly made studies with attention to the fact that compressive stress applied from the above-described ribbon matrix 13 to the optical fibers 12 is a cause of an increase in polarization mode dispersion, and found that compressive stress can be suppressed to a low magnitude by using as the ribbon matrix 13 a resin having a glass transition temperature of 80 to 130° C. and a Young's modulus of 800 to 2100 MPa, and that an optical fiber ribbon having toughness and separation ability into individual fibers required of the optical fiber ribbon 11 can be obtained by using such a resin.

That is, the temperature of the ribbon matrix increased in the resin setting step reaches a hundred and several ten degrees, and the maximum temperature reached is higher than the glass transition temperature of the ribbon matrix. Each of resin materials including ultraviolet curing resins is in a rubber state in a temperature range higher than the glass transition temperature, and the expansion/shrinkage percentage of its volume with change in temperature in this temperature range is about thrice that in a temperature range lower than the glass transition temperature in which it is in a glass state. In the case of a resin having a high glass transition temperature, therefore, the time period during which the resin is in a rubber state in which the shrinkage percentage is high is short in the process of cooling to room temperature in which the temperature rises to a hundred and several ten degrees and setting is completed, and the shrinkage percentage in the cooling process is lower than those of materials of lower glass transition temperatures. From these viewpoints, a resin having a higher glass transition temperature is preferred as a ribbon matrix material for suppressing compressive stress to a low magnitude in the ribbon matrix 13 and reducing polarization mode dispersion.

However, the glass transition temperature of a resin relates to the hardness and toughness of the resin to a certain degree. In many cases, if the glass transition temperature is excessively high, the ribbon matrix is made hard and brittle and the ribbon matrix layer breaks when receiving a small external force, and it becomes difficult to maintain the shape of the optical fiber ribbon. Also, a hard brittle resin forms an easily breakable ribbon matrix layer and makes it difficult to remove the ribbon matrix layer at a time. Therefore such a resin is undesirable in satisfying coating-strip ability and separation ability into individual fibers requirements for the optical fiber ribbon. On the other hand, in a case where the glass transition temperature is low and the Young's modulus of the ribbon matrix is low, the adhesiveness of the ribbon matrix is comparatively high and a problem arises that a coloring layer is separated at the time of single-core splitting and it is difficult to remove the ribbon matrix. From these viewpoints, a suitable resin as a ribbon matrix material for reducing polarization mode dispersion has a glass transition temperature in the range from 80 to 130° C. and a more preferable resin has a glass transition temperature in the range from 90 to 110° C. Further, from consideration of the toughness, coating strip ability and separation ability into individual fibers required of a ribbon matrix material, a ribbon matrix material having a glass transition temperature in the above-described range and a Young's modulus in the range from 800 to 2100 MPa is preferred. A further preferable range of Young's modulus is from 900 to 1500 MPa.

The above-described ultraviolet curing resin is, for example, formed of a photopolymerizable prepolymer, a photopolymerizable monomer and a photopolymerization initiator. Examples of the photopolymerizable prepolymer are an urethane acrylate resin, an epoxy acrylate resin, a polyol acrylate resin, a butadiene acrylate resin, a polyester acrylate resin and a silicone acrylate resin. Examples of the photopolymerizable monomer are vinylpyrrolidone, hydroxyethyl acrylate and ethylhexyl acrylate. Examples of the photopolymerization initiator are a benzophenone compound, an acylphosphine oxide compound and an acetophenone compound.

When the composition of the above-described ultraviolet curing resin is formulated, it is possible to control the Young's modulus and the glass transition temperature to the desired values to some effect, for example, by changing the compatibility with the photopolymerizable prepolymer and the blending ratio to the photopolymerizable prepolymer, by blending a polyfunctional monomer for photopolymerization, or by blending a plurality of photopolymerizable prepolymers differing in polymerization degree (molecular weight). For example, Japanese Patent Application Laid-Open No. 2004-354889 discloses a method of increasing the Young's modulus by increasing the amount of blending of a bifunctional monomer such as ethylene oxide modified bisphenol-A diacrylate. Also, Japanese Patent Application Laid-Open No. H11-011986 discloses a method of controlling the glass transition temperature and the Young's modulus by changing the blending ratio of polyurethane oligomers differing in average molecular weight.

The description has been made with respect to the case of using an ultraviolet curing resin. In the case of using a thermoplastic resin or a thermosetting resin, however, the same action to produce compressive stress in the ribbon matrix 13 also takes place and it is also preferable to set the glass transition point in the same range.

The inventors of the present invention have also found that the thickness a of the ribbon coating layer applied on the upper and lower sides of the plurality of optical fibers and the thickness b of the ribbon coating layer applied outside the optical fibers in the outermost positions in the optical fiber ribbon 11 always satisfy 1<b/a≦2; the ribbon coating layer thickness a is 10 μm or less; and the ribbon coating layer thickness b is smaller than 20 μm.

As disclosed in non-patent documents 1 and 2, the glass optical fibers in the optical fiber ribbon have their respective polarization mode dispersion characteristics, influenced by stresses residing the optical fiber coating layers (primary coating layer 15, secondary coating layer 16) and the ribbon coating (ribbon matrix 13) of the optical fiber ribbon. Prediction of the tendency of these polarization mode dispersions from the birefringence estimated from the above-described stress has already been described. According to the studies made as described in non-patent documents 1 and 2, however, a predicted stress is multiplied by a certain elasto-optic coefficient to be converted into birefringence, and the estimated tendency of the stress value in each optical fiber and the tendency of polarization mode dispersion coincide with each other. The inventors of the present invention have computed stresses residing in optical fiber ribbon cross sections of various sizes by consulting the methods in non-patent documents 1 and 2.

The analysis thereby made has revealed that in the case where the above-described ribbon matrix 13 has characteristics in the preferable ranges according to the present invention, the stresses respectively applied to the optical fibers in the outermost and inner positions exhibit mutually contradictory behaviors with respect to the thickness of the optical fiber ribbon. That is, while the stress undergone from the ribbon layer by the optical fibers in the outermost positions decreases with increase in thickness, the stress undergone by the optical fibers in the inner positions increases with increase in thickness. As a result of close examination on these mutually contradictory behaviors, it has been clarified that when the thickness a of the ribbon coating layer applied on the upper and lower sides of the plurality of optical fibers and the thickness b of the ribbon coating layer applied outside the optical fibers in the outermost positions in the optical fiber ribbon 11 satisfy 1<b/a≦2, each of the stresses respectively applied to the optical fiber ribbon in the outermost and inner positions can be minimized, neither of the stresses being prominently high.

Further, measurements have been made on polarization mode dispersion in several optical fiber ribbons actually manufactured to confirm that the estimated value of stress obtained by analysis and the measured value of polarization mode dispersion correlate well with each other, and that the maximum value of polarization mode dispersion in the optical fiber ribbon does not exceed 0.2 ps/km^{1/2} when the estimated value of stress to the optical fibers at the inner positions does not exceed 0.2 MPa. By closely checking the measured values of polarization mode dispersion obtained and the above-described analysis results with each other, it has also been found that in the case where the above-described ribbon matrix 13 has characteristics in the preferable ranges according to the present invention, it is preferable that the thickness a of the ribbon coating layer applied on the upper and lower sides of the plurality of optical fibers and the thickness b of the ribbon coating layer applied outside the optical fibers in the outermost positions in the optical fiber ribbon 11 always satisfy 1<b/a≦2; the ribbon coating layer thickness a be 10 μm or less; and the ribbon coating layer thickness b be smaller than 20 μm.

### EXAMPLES

According to the present example, an optical fiber 12 having an outside diameter of 250 μm was made by applying on a glass fiber 14 having an outside diameter of 125 μm protective coating layers constituted by a soft primary coating layer 15 and a hard secondary coating layer 16 formed of urethane acrylate ultraviolet curing resins, ultraviolet-curing the protective coating layers, applying thereon an ultraviolet curing colored material to form a coloring layer 17, and ultraviolet-curing the coloring layer 17. An optical fiber ribbon 11 was made by placing four optical fibers 12 side by side in a band form and collectively ribbon coating the optical fibers with a ribbon matrix 13 which was an urethane acrylate ultraviolet curing resin.

Table 1 shows the results of evaluation including the results of evaluation of polarization mode in optical fiber ribbons 11 made in this way, the results of evaluation of the separation ability into individual fibers and the external appearance and the results of evaluation of the glass transition temperature and the Young's modulus of the ribbon matrix 13. Further, estimation of stresses applied to the optical fibers 12 contained in the optical fiber ribbon 11 was performed by consulting the methods suggested in non-patent documents 1 and 2. Table 1 also shows the results of analysis. The method of measuring the characteristics shown in Table 1 and the method of analyzing the characteristics are as described below.

In measurement on polarization mode dispersion in the optical fiber ribbon, 1 km of the optical fiber ribbon was bundled in the form of a coil having a diameter of 30 cm, and measurement was made on each of the four optical fibers by the Jones matrix method. The higher one of the polarization mode dispersion in the tow optical fibers at the inner positions in the four optical fibers was used as the polarization mode dispersion value of the optical fiber ribbon.

In the optical fiber ribbon effective in improving the communication capacity in wavelength multiplex communication, the polarization mode dispersion value is preferably 0.2 ps/km^{1/2} or less, more preferably in a range from 0.1 ps/km^{1/2} to a lower value.

The separation ability into individual fibers was evaluated as to whether or not the ribbon matrix 13 could be thoroughly removed from the optical fiber 12, when the ribbon matrix 13 is manually removed from the optical fiber ribbon 11 at a room temperature. The length of the optical fiber ribbon evaluated is 200 mm. Determination is made on criteria in terms of the state of removal a 100 mm central portion of the 200 mm optical fiber ribbon and the time taken to remove the central portion. If leavings of the ribbon matrix 13 remain on the optical fiber 12, separation of a colored portion occurs or it is difficult to remove the resin, the optical fiber ribbon is determined as a failure. It is desirable that the ribbon matrix 13 can be easily removed continuously when it is to be removed. Accordingly, if the ribbon matrix 13 tends to break when removed so that the time taken to complete removal through the predetermined length is long, the optical fiber ribbon is also determined as a failure. A time of 3 minutes or shorter taken to complete removal through the predetermined length was used as an evaluation criterion. A time not longer than 1 minute and 30 seconds was marked with \textcircled{◯}, and a time not longer than 3 minutes was marked with ◯. A longer time is marked with X indicating a failure.

The external appearance is evaluated as described below. An operation to take up around a drum the optical fiber ribbon 11 wound around another drum is performed. During this take-up, variation of the thickness through the entire length is measured with an optical size measuring device. A portion at which the amplitude presenting the thickness exceeds 20 μm is checked with the eye to determine whether or not the ribbon layer is cracked. If the ribbon layer is cracked, optical fiber ribbon is determined as a failure.

The method of measuring the glass transition temperature will be described. According to the method of measuring the glass transition temperature, temperature dispersion is measured at a frequency of 1 Hz through a temperature range from −100 to 200° C. by using a dynamic viscoelasticity measuring device (DMS6100, a product from Seiko Instruments Inc.) and the temperature at which the loss tangent is maximized is recognized as the glass transition temperature. A piece of the optical fiber ribbon 11 cut out with a shaving blade is used as a specimen to be measured, and measurement is made through a specimen length of 30 mm.

The Young's modulus is measured as described below. A piece of ribbon matrix 13 cut out from the optical fiber ribbon 11 with a shaving blade is used as a test piece of a test piece length of 40 mm. According to the test procedure specified in JIS K7113, the above-described test piece is pulled over a gage length of 25 mm at a pull speed of 1 mm/min. The secant modulus is computed from the tensile strength at an elongation of 2.5%. The sectional area of the test piece is required in computation of the secant modulus. The sectional area is measured by observing a cut sectional surface of the test piece at a 100:1 magnification with an optical microscope, taking the observed image into a computer and using a piece of image analysis software.

For estimation of stresses applied to the optical fibers 12 contained in the optical fiber ribbon 11, the shape in which four optical fibers 12 were placed side by side and collectively covered with the ribbon matrix 13, i.e., an urethane acrylate ultraviolet curing resin, was analyzed by using a piece of finite-element method analysis software MSC-MARK (product from MSC Software Corporation). In performing analysis, the width and thickness of the product of the above-described optical fiber ribbon were used as an analysis model. Modifications were made on the MSC-MARK such as to set the width and thickness to arbitrary values, and analysis was performed on the shape in each case.

The analysis model was constructed as a four-core optical fiber ribbon. However, since the optical fiber ribbon model is bilaterally symmetric, the stresses estimated in the optical fibers at the left and right outermost positions coincide with each other and the stresses estimated in the optical fibers at the left and right inner positions also coincide with other. Further, since as described above the maximum value of polarization mode dispersion in the optical fiber ribbon does not exceed 0.2 ps/km^{1/2} when the estimated value of stress to the optical fibers at the inner positions does not exceed 0.2 MPa, the value of one of the optical fibers at the inner positions was shown in Table 1 and determination was made with respect to this value.

Entries of numeric values for polarized mode dispersion in Table 1 are for the articles actually made and having polarization mode dispersion measured, and oblique lines indicate the case where only stress estimation was performed.

TABLE 1

| | | | | Glass | | | | Inner | |
|---|---|---|---|---|---|---|---|---|---|
| | | | | transi- | | | | fiber | Polariza- |
| | | | | tion | | Single- | | esti- | tion mode |
| | | | | tempera- | Young's | core | External | mated | disper- |
| | a | b | | ture | modulus | splitt- | appear- | stress | sion |
| No. | μm | μm | b/a | ° C. | MPa | ability | ance | MPa | ps/km^{1/2} |
| 1 | 7.5 | 15 | 2.00 | 128 | 2010 | | | 0.068 | |
| 2 | 7.5 | 15 | 2.00 | 93 | 1020 | ⊚ | Not | 0.043 | 0.089 |
| | | | | | | | cracked | | |
| 3 | 7.5 | 15 | 2.00 | 87 | 888 | | | 0.074 | |
| 4 | 10 | 18 | 1.80 | 128 | 2010 | | | 0.191 | |
| 5 | 10 | 18 | 1.80 | 93 | 1020 | | | 0.182 | |
| 6 | 10 | 18 | 1.80 | 87 | 888 | | | 0.196 | |
| 7 | 8 | 10 | 1.25 | 128 | 2010 | ◯ | Not | 0.099 | 0.110 |
| | | | | | | | cracked | | |
| 8 | 8 | 10 | 1.25 | 93 | 1020 | ⊚ | Not | 0.086 | 0.092 |
| | | | | | | | cracked | | |
| 9 | 8 | 10 | 1.25 | 87 | 888 | ⊚ | Not | 0.121 | 0.169 |
| | | | | | | | cracked | | |
| 10 | 5 | 7.5 | 1.50 | 128 | 2010 | | | 0.091 | |
| 11 | 5 | 7.5 | 1.50 | 93 | 1020 | | | 0.088 | |
| 12 | 5 | 7.5 | 1.50 | 87 | 888 | | | 0.105 | |
| Comparative | 11 | 20 | 1.82 | 128 | 2010 | | | 0.222 | |
| Example 1 | | | | | | | | | |
| Comparative | 11 | 20 | 1.82 | 93 | 1020 | | | 0.214 | |
| Example 2 | | | | | | | | | |
| Comparative | 11 | 20 | 1.82 | 87 | 8880 | | | 0.243 | |
| Example 3 | | | | | | | | | |
| Comparative | 22.5 | 15 | 0.67 | 93 | 1020 | ⊚ | Not | 0.247 | 0.231 |
| Example 4 | | | | | | | cracked | | |
| Comparative | 22.5 | 15 | 0.67 | 87 | 888 | ⊚ | Not | 0.260 | |
| Example 5 | | | | | | | cracked | | |
| Comparative | 22.5 | 22.5 | 1.00 | 93 | 1020 | | | 0.312 | |
| Example 6 | | | | | | | | | |
| Comparative | 22.5 | 27.5 | 1.22 | 93 | 1020 | | | 0.257 | |
| Example 7 | | | | | | | | | |
| Comparative | 32.5 | 27.5 | 0.85 | 128 | 2010 | ◯ | Not | 0.365 | 0.270 |
| Example 8 | | | | | | | cracked | | |
| Comparative | 32.5 | 27.5 | 0.85 | 93 | 1020 | | | 0.329 | |
| Example 9 | | | | | | | | | |
| Comparative | 32.5 | 40 | 1.23 | 93 | 1020 | | | 0.374 | |
| Example 10 | | | | | | | | | |
| Comparative | 7.5 | 15 | 2.00 | 135 | 2681 | Leavings | Cracked | 0.051 | 0.026 |
| Example 11 | | | | | | exist | | | |
| Comparative | 7.5 | 15 | 2.00 | 77 | 645 | Colored | Not | 0.338 | 0.289 |
| Example 12 | | | | | | portion | cracked | | |
| | | | | | | separated | | | |
| Comparative | 5 | 15 | 3.00 | 77 | 645 | Colored | Not | 0.351 | 0.220 |
| Example 13 | | | | | | portion | cracked | | |
| | | | | | | separated | | | |
| Comparative | 5 | 15 | 3.00 | 69 | 294 | | | 0.484 | |
| Example 14 | | | | | | | | | |

In Examples 1 to 12, the ribbon matrix in the optical fiber ribbon had a glass transition temperature in the range from 80 to 130° C. and a Young's modulus in the range from 800 to 2100 MPa; the thickness a of the ribbon coating layer applied on the upper and lower sides of the plurality of optical fibers and the thickness b of the ribbon coating layer applied outside the optical fibers in the outermost positions in the optical fiber ribbon 11 always satisfied 1<b/a≦2; the ribbon coating layer thickness a was 10 μm or less; and the ribbon coating layer thickness b was smaller than 20 μm. In these optical fiber ribbons, all the estimated values of stresses applied to the optical fibers at the inner positions were 0.2 MPa or less. The result of evaluation of polarization mode dispersion in each of the optical fiber ribbons corresponding to the models subjected to analysis and actually made was good, 0.2 ps/km^{1/2} or less. Also, no problem was recognized with the separation ability into individual fibers and the external appearance.

In Example 2, the ribbon matrix had a glass transition temperature of 90 to 110° C. and a Young's modulus of 900 to 1500 MPa, and the estimated value of stresses applied to the optical fibers at the inner position was smaller than that in the optical fiber ribbons in Examples 1 and 3 having the same ribbon coating thicknesses a and b.

Similarly, in Example 8, the estimated value of stresses applied to the optical fibers at the inner positions was smaller than that in Examples 7 and 9, and the value shown as the result of evaluation of polarization mode dispersion was also lower.

The tendency of the estimated value of stresses applied to the optical fibers at the inner positions to be lower was also exhibited in Examples 5 and 11 in comparison with the other optical fiber ribbons having the same values a and b. It was shown that setting the glass transition temperature of the ribbon matrix within the range from 90 to 110° C. and the Young's modulus within the range from 900 to 1500 MPa was more preferable.

The separation ability into individual fibers is such that since the thickness of the ribbon layer is set comparatively thin, the ribbon layer resin becomes breakable more easily and it is difficult to continuously remove the ribbon layer resin if the hardness of the ribbon layer is increased. In the case of Example 7, it was possible to perform single-core splitting within the predetermined time period. In most cases, however, a time limit of 3 minutes was substantially fully consumed. In Examples 2, 8, and 9, it was possible to perform single-core splitting within a time period substantially shorter than the time limit. Further, in Examples 2 and 8, the measured value of polarization mode dispersion was 0.1 ps/km^{1/2} or less, shown as a more preferable result.

On the other hand, in comparative Examples 1 to 10, the ribbon matrix in the optical fiber ribbon had a glass transition temperature in the range from 80 to 130° C. and a Young's modulus in the range from 800 to 2100 MPa, but the thickness a of the ribbon coating layer applied on the upper and lower sides of the plurality of optical fibers is 11 μm or more and the thickness b of the ribbon coating layer applied outside the optical fibers in the outermost positions in the optical fiber ribbon 11 was 20 μm or more. Accordingly, the estimated values of stresses applied to the optical fibers at the inner positions exceeded 0.2 MPa. Also, the result of evaluation of polarization mode dispersion in each of the optical fiber ribbons corresponding to the models subjected to analysis and actually made exceeded 0.2 ps/km^{1/2}.

In comparative Example 11, the thickness a of the ribbon coating layer applied on the upper and lower sides of the plurality of optical fibers and the thickness b of the ribbon coating layer applied outside the optical fibers in the outermost positions in the optical fiber ribbon 11 were 10 μm or less and smaller than 20 μm, respectively. However, the glass transition temperature and the Young's modulus of the ribbon matrix of the optical fiber ribbon were respectively above the range from 80 to 130° C. and the range from 800 to 2100 MPa. Accordingly, the separation ability into individual fibers was disadvantageously low and a crack was recognized in the external appearance.

In comparative Examples 12 to 14, the thickness a of the ribbon coating layer applied on the upper and lower sides of the plurality of optical fibers and the thickness b of the ribbon coating layer applied outside the optical fibers in the outermost positions in the optical fiber ribbon 11 were 10 μm or less and smaller than 20 μm, respectively. However, the glass transition temperature and the Young's modulus of the ribbon matrix of the optical fiber ribbon were respectively below the range from 80 to 130° C. and the range from 800 to 2100 MPa. Accordingly, the estimated values of stresses applied to the optical fibers at the inner positions exceeded 0.2 MPa. Also, the result of evaluation of polarization mode dispersion in each of the optical fiber ribbons corresponding to the models subjected to analysis and actually made exceeded 0.2 ps/km^{1/2}.

The present invention is not limited to the above-described embodiments. Various modifications in the embodiment can be made in the implementation stage without departing from the gist of the invention. Further, each of the above-described embodiments includes various stages of the invention. Variations of the invention can be extracted according to suitable combinations of the plurality of constituent features disclosed.

For example, in a case where even if several constituent features in all the constituent features shown in the above-described embodiments are removed, the problem described in the section “PROBLEM TO BE SOLVED BY THE INVENTION” can be solved and the effects described in the section “ADVANTAGES OF THE INVENTION” can be obtained, the arrangement formed by removing the constituent features can be extracted as the invention.

1. An optical fiber ribbon comprising a plurality of optical fibers having glass optical fibers and coating layers provided on the peripheries of the glass optical fibers, the optical fibers being in a bundled form, and a ribbon coating formed around the plurality of optical fibers so as to integrally combining the plurality of optical fibers, wherein the glass transition temperature of the ribbon coating is within the range from 80 to 130° C.; the Young's modulus of the ribbon coating is within the range from 800 to 2100 MPa; the thickness a of the ribbon coating layer applied on the upper and lower sides of the plurality of optical fibers and the thickness b of the ribbon coating layer applied outside the optical fibers in the outermost positions in the optical fiber ribbon always satisfy 1<b/a≦2; the ribbon coating layer thickness a is 10 μm or less; and the ribbon coating layer thickness b is smaller than 20 μm.

2. The optical fiber ribbon according to claim 1, wherein the glass transition temperature of the ribbon coating is within the range from 90 to 110° C. and the Young's modulus of the ribbon coating is within the range from 900 to 1500 MPa.
